(19) United States
(12) Patent Application Publication
(10) Pub. No.: US 2007/0026860 A1
(43) Pub. Date: Feb. 1, 2007

(54) Mobile communication terminal and communication control method

(75) Inventor: Hideki Okamoto, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION

(21) Appl. No.: 11/475,352

(22) Filed: Jun. 27, 2006

(30) Foreign Application Priority Data
Jun. 28, 2005 (JP) P.2005-188638

(51) Int. Cl. H04Q 7/20

(52) U.S. Cl. 455/436

(57) ABSTRACT

A mobile communication terminal includes a first communication section which receives a signal transmitted of a first communication system in a first cycle, a second communication section which receives a signal of a second communication system in a cycle, a reception-halt control section which controls so that the first communication section halts reception during a predetermined period, when the first communication section fails in reception of a signal more than predetermined number of times, a handoff processing section which performs handoff processing in which the connected base station is switched on the basis of signal quality of the signal received by the second communication section, and a reception-resume control section which controls so as to resume reception of the signal by the first communication section, when the handoff processing section performs handoff processing during such a period that reception of the signal by the first communication system is halted.

This application claims foreign priority based on Japanese Patent application No. 2005-188638, filed Jun. 28, 2005, the content of which is incorporated herein by reference in its entirety.

### BACKGROUND OF THE INVENTION

1. Field of the Invention

This invention relates to a mobile communication terminal which performs communication by use of different two communication systems, and a communication control method in the mobile communication terminal, and especially, relates to a mobile communication terminal which can perform communication by CDMA (Code Division Multiple Access) 2000 1× MC (Multi Carrier) system, and CDMA2000 1× EVDO (EVolution Data Only) system, and a communication method in the mobile communication terminal.

2. Description of the Related Art

A mobile communication terminal, which can perform communication with a base station by switching different two communication systems, so-called dual system mobile communication terminal, has been known. For example, JP-A-2004-193852 discloses a mobile communication terminal which performs communication by switching CDMA2000 1× MC (Multi Carrier) system which is used for voice telephonic communication and data communication, and CDMA2000 1× EVDO (EVolution Data Only) system which is used for data communication.

For example, in a mobile communication terminal of a dual system; CDMA2000 1× EVDO (hereinafter, abbreviated as EVDO system) and CDMA2000 1× MC (hereinafter, abbreviated as 1× system), receives pilot signals from a connected base station which is now connected, and a peripheral base station which is located at the periphery of the connected base station, respectively on a cyclic basis in an idle state, and thereby, stability of communication is realized.

FIGS. 3 and 4 are timing charts which show reception timing of pilot signals in the EVDO system and the 1× system during an idle state, and both of the communication systems are configured so as to receive pilot signals from a connected base station and a peripheral base station, respectively, in a cycle of every 5.12 seconds. By receiving pilot signals from a connected base station which is now connected, and a peripheral base station which is located at the periphery of the connected base station, respectively on a cyclic basis in an idle state, stability of communication is realized. In addition, in the both communication systems, by performing processing of switching a connected base station to a base station which has better signal quality on the basis of signal quality of a pilot signal received from a connected base station and signal quality of a pilot signal received from a peripheral base station, stability of communication is realized.

By the way, this connected base station switching processing is referred to as “handoff” in this specification. In addition, in the 1× system, pilot signal reception on a cyclic basis is used for not only preparation for handoff processing, but also incoming call monitoring for the purpose of preparing for an incoming call of voice telephonic communication.

In a case of a related dual system mobile communication terminal, the terminal is judged to be in a status of an outside of a service area when it fails in cyclic reception of a pilot signal continuously in the EVDO system, and the terminal goes into a state in which reception of a pilot signal is halted for long time.

That is, in the EVDO system, pilot signals are received from a connected base station and a peripheral base station which is located at the periphery of the connected base station in a predetermined cycle (5.12 seconds), but if it is not possible to receive a pilot signal from any base station for a predetermined number of times, it is judged that it is in a status of an outside of a service area, and as shown in FIG. 4, reception of a pilot signal is halted for a fixed period of time (300 seconds) which exceeds the predetermined cycle.

By performing pilot signal reception halt processing in this way, power saving is realized by suppressing driving of a wireless communication section as much as possible, but on the one hand, there is such a problem that, once reception of a pilot signal is halted due to deterioration of an electromagnetic wave status, it becomes impossible to perform communication by the EVDO system for long time (period of 300 seconds). On that account, there is such a problem that, even if an electromagnetic wave status in a certain area is deteriorated suddenly due to a problem such as fading, although it is possible to receive a pilot signal without problems if a user moves to a peripheral area in which an electromagnetic wave status is good, a communication impossible status in the EVDO system continues for a long time.

### SUMMARY OF THE INVENTION

The present invention has been made in view of the above circumstances, and provides a dual system mobile communication terminal which can shorten a communication impossible status due to reception halt of a pilot signal.

In some implementations, a mobile communication terminal of the invention for performing communication by a first communication system and a second communication system respectively comprises:

a first communication section which receives a signal transmitted from a connected base station of the first communication system, and a signal transmitted from a peripheral base station located at the periphery of the connected base station, respectively in a first cycle;

a second communication section which receives a signal transmitted from a connected base station of the second communication system, and a signal transmitted from a peripheral base station located at the periphery of the connected base station, respectively in a second cycle;

a reception-halt control section which performs a control so that the first communication section halts reception of the signal during a predetermined period which is longer than the first cycle, in a case where the first communication section fails in the reception of the signal more than a predetermined number of times;

a handoff processing section which performs handoff processing for switching between the connected base station and the base station to be connected based on a signal quality of the signal received by the second communication section; and a reception-resume control section which performs a control so as to resume the reception of the signal by the first communication section, when the handoff processing section performs the handoff processing of the second communication system while the reception of the signal by the first communication system is halted.

In addition, in the mobile communication terminal of the invention, the first communication system is CDMA2000 1× EVDO system, and the second communication system is CDMA2000 1× MC system.

Furthermore, in some implementations, a communication control method of the invention in a mobile communication terminal for performing communication by a first communication system and a second communication system respectively comprises:

receiving a first signal transmitted from a connected base station of the first communication system, and a first signal transmitted from a peripheral base station located at the periphery of the connected base station, respectively in a first cycle;

receiving a second signal transmitted from a connected base station of the second communication system, and a second signal transmitted from a peripheral base station located at the periphery of the connected base station, respectively in a second cycle;

performing handoff processing for switching between the connected base station and the base station to be connected based on a signal quality of the received second signal;

performing a control so that the reception of the first signal by the first communication system is halted during a predetermined period which is longer than the first cycle, in a case where the reception of the first signal is failed more than a predetermined number of times; and

performing a control so as to resume the reception of the first signal by the first communication system, when the handoff processing of the second communication system is performed while the reception of the first signal by the first communication system is halted.

According to the present invention, by checking a processing operation in one communication system in a mobile communication terminal which can perform communication by different two communication systems, it is possible to shorten a communication impossible status due to reception halt of a pilot signal in the other communication system.

### BRIEF DESCRIPTION OF THE DRAWINGS

FIG. 1 is a schematic view which shows a communication system which is used for a mobile communication terminal relating to an embodiment of the present invention to perform communication.

FIG. 2 is a block diagram which shows substantial portions of the mobile communication terminal relating to an embodiment of the present invention and substantial portions of base stations.

FIG. 3 is a timing chart which shows timing of receiving a pilot signal of the mobile communication terminal relating to an embodiment of the present invention.

FIG. 4 is a timing chart which shows timing of halting reception of a pilot signal of the mobile communication terminal relating to an embodiment of the present invention.

FIG. 5 is a flow chart which shows communication control relating to an embodiment of the present invention.

### DESCRIPTION OF THE PREFERRED EMBODIMENTS

Hereinafter, an embodiment of the present invention will be explained on the basis of drawings.

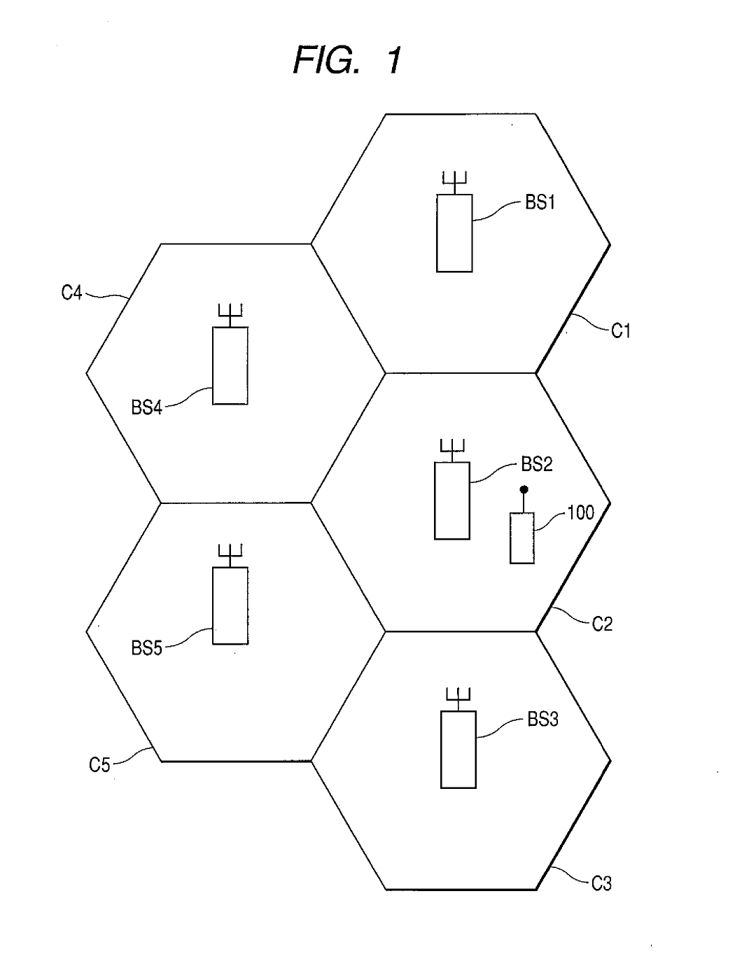

FIG. 1 is a schematic view which shows a communication system including a portable telephone which is a mobile communication terminal of an embodiment of the present invention. According to FIG. 1, the communication system is configured by including a plurality of cells (C1-C5), and base stations (BS1-BS5) are disposed in respective cells.

A mobile communication terminal 100 is configured so as to perform wireless communication with specific base station (BS1-BS5), and according to the same figure, the mobile communication terminal 100 exists in the cell C2, and is connected to the base station BS2, in an idle state. In this way, a base station, which is connected in an idle state, is called as “a connected base station” in the specification. In addition, an area, which is covered by a base station for wireless communication, is called as a “cell”.

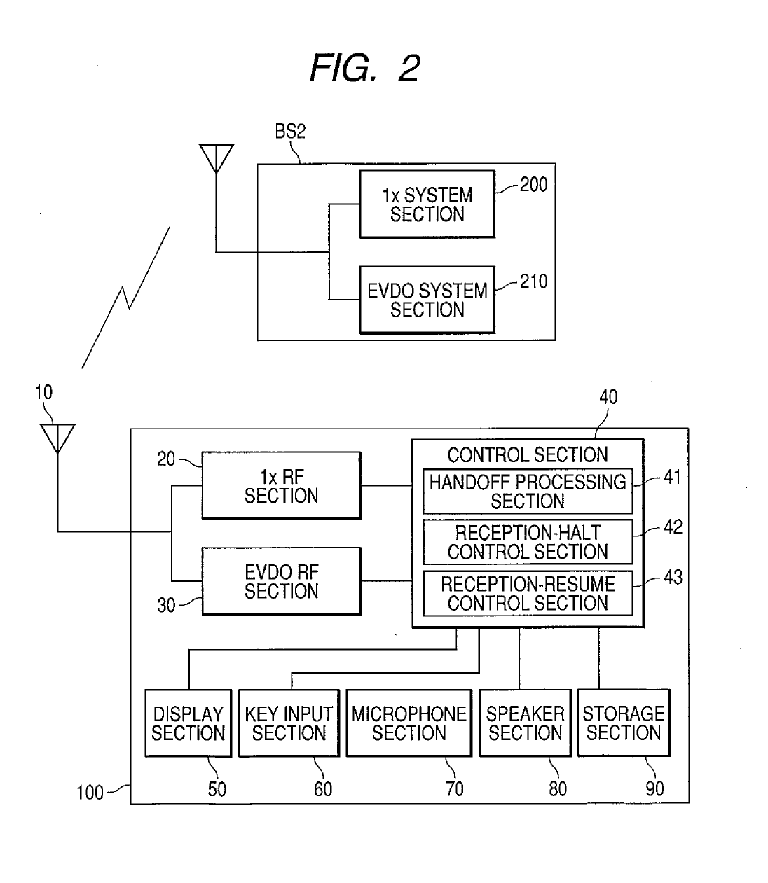

FIG. 2 is a block diagram which indicates substantial portions of the mobile communication terminal 100 and the base station BS2.

The mobile communication terminal 100 is configured so as to be able to perform communication by switching CDMA2000 1× MC (Multi Carrier) communication system (1× system) which is used for voice telephonic communication and data communication, and CDMA2000 1× EVDO (EVolution Data Only) communication system (EVDO system) which is used only for data communication, by use of a common one antenna 10.

The base station BS2 in the figure is equipped with an 1× system section 200 which corresponds to the 1× system, and an EVDO system section 210 which corresponds to the EVDO system, and is a base station which can perform communication by both communication systems of the 1× system and the EVDO system. Then, the 1× system is normally used for telephonic communication through telephone line switching system, and the EVDO system is used for performing data communication through packet switching system. Meanwhile, in FIG. 2, BS2 is illustrated for descriptive purposes, but other base stations BS1, BS3-BS6 have the same configuration.

The mobile communication terminal 100 has an 1× RF (radio frequency) section 20, and an EVDO RF section 30, respectively.

The 1× RF section 20 converts data signals or audio signals which are transmitted in the 1× system, into high frequency signals, and transmits them to the 1× system section 200 of the base station BS2 through the antenna 10. In addition, the 1× RF section 20 converts high frequency signals which are received from the 1× system section 200 of the base station BS2 through the antenna 10, into data signals or audio signals.

The EVDO RF section 30 converts data signals which are transmitted in the EVDO system, into high frequency signals, and transmits them to the EVDO system section 210 of the base station BS2 through the antenna 10. In addition, the EVDO RF section 30 converts high frequency signal which are received from the EVDO system section 210 through the antenna 10, into data signals.

A control section 40 controls each section of the mobile communication terminal 100 entirely. For example, the control section 40 controls the 1× RF section 20 and the EVDO RF section 30, and performs switching of two communication systems of the 1× system and the EVDO system. In particular, during an idle state, the control section 40 performs switching of two communication systems selectively at intervals of a predetermined period, and receives pilot signals from a plurality of base stations, respectively, in the both communication systems, and thereby, performs an idle operation.

In addition, the control section 40 has handoff processing section 41, a control section 42 for halting reception of a signal (reception-halt control section 42), and a control section 43 for resuming reception of a signal (reception-resume control section 43), which are expressed by programs, respectively.

A display section 50 is a display device such as LCD (Liquid Crystal Display), and is configured so as to display various information by an instruction from the control section 40.

A key input section 60 is an input device which includes a group of plural keys such as alphanumeric and direction keys, and is configured so as to send an input signal to the control section 40.

A microphone section 70 is a microphone which collects sounds, and is configured so as to send inputted sound signals to the control section 40.

A speaker section 80 is a speaker which gives out sounds, and is configured so as to give out sound which relates to sound signals sent from the control section 40.

A storage section 90 is a storage device which includes a ROM (Read Only Memory), etc., and stores data and information which become necessary for various functions of the mobile communication terminal 100.

Next, an idle operation of the mobile communication terminal 100 will be explained.

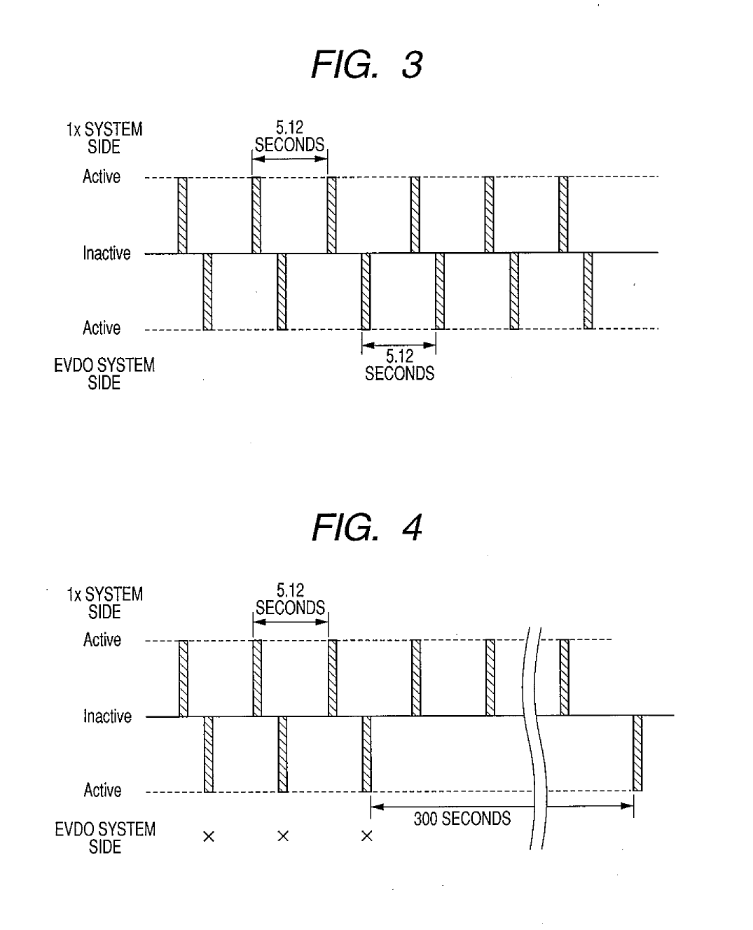

FIGS. 3 and 4 are timing charts which show timing of performing reception of a pilot signal at the time of an idle operation in the 1× system and the EVDO system.

According to FIG. 3, during a period of an idle state, the handoff processing section 41 of the control section 40 drives the 1× RF section 20 at predetermined period intervals of 5.12 seconds, and receives pilot signals from a connected base station (in FIG. 2, BS2) and a peripheral base station (in FIG. 2, at least one of BS1, BS3, BS4, and BS5) which is located at the periphery of the connected base station, respectively. When receiving a pilot signal from each base station, the handoff processing section 41 compares signal quality of each pilot signal, and in case that there is a peripheral base station having stronger signal quality than that of the connected base station, it performs handoff processing of switching that peripheral base station to a new connected base station. By performing control in this way, the best base station is always used as a connected base station on the 1× system side, and it is possible to realize stability of communication.

In the same manner, also on the EVDO system side, the handoff processing section 41 of the control section 40 drives the EVDO RF section 30 at predetermined period intervals of 5.12 seconds, and performs reception of a pilot signal from each base station, and handoff processing based on signal quality of each pilot signal.

Here, on the EVDO system side, in case that it is not possible to receive a pilot signal from any one of a connected base station and peripheral base stations for a predetermined number of times, the control section 40 judges that it is an outside of a service area of the EVDO system, and the reception-halt control section 42 of the control section 40 controls in such a manner that reception of a pilot signal is not performed by halting the EVDO RF section 30 during a predetermined period (e.g., period of 300 seconds) which is longer than the predetermined cycle (5.12 seconds). During this predetermined period, the EVDO RF section 30 is halted, and does not perform reception of a pilot signal, and if it is possible to receive a pilot signal when reception of a pilot signal is resumed after the predetermined period has passed, the control section 40 judges that it goes back to a status of an inside of a service area of the EVDO system.

On the one hand, since the 1× system is mainly used for telephonic communication, there is need to always perform monitoring of an incoming call, and therefore, even if it is not possible to receive a pilot signal once or twice, there is not such a case that reception of a pilot signal is halted for long time, and the 1× system continues to receive the pilot signal at predetermined intervals (5.12 seconds).

On that account, on the EVDO system side, once it is judged that the terminal 100 is an outside of a service area of the EVDO system, the EVDO system does not perform reception of a pilot signal for a period longer than the predetermined cycle, and therefore, there is such inconvenience that the terminal 100 can not go back to the status of an inside of a service area promptly, even if the terminal 100 is moved into a cell in which an electromagnetic wave status is favorable by user's movement, etc., within for example, 300 seconds. However, in the present invention, it is configured in such a manner that, when handoff processing is performed on the 1× system side during a period of halting reception of a pilot signal on the EVDO system side, reception of a pilot signal on the EVDO system side is resumed.

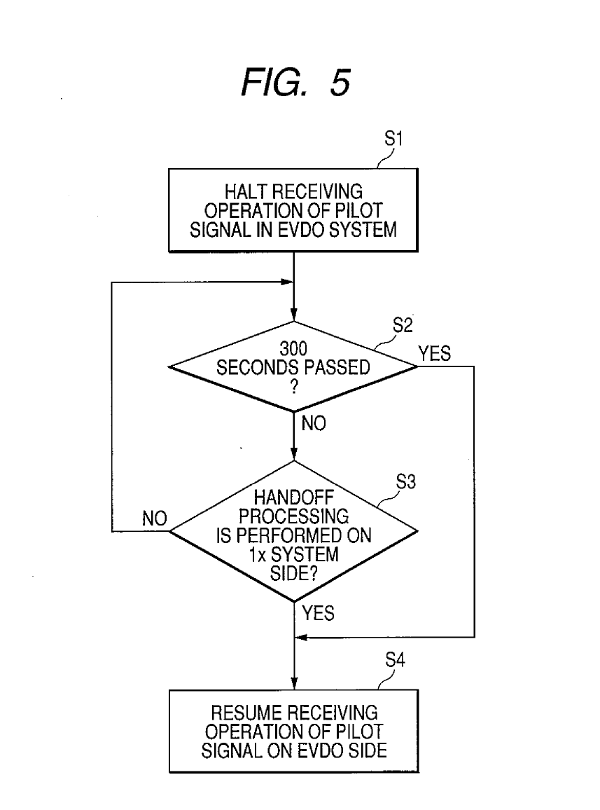

FIG. 5 shows a flow chart of a receiving operation of a pilot signal on the EVDO system side.

For example, it is assumed, as shown in FIG. 1, that the mobile communication terminal 100 exists in the cell C2, and is connected to the base station BS2 as a connected base station, and the 1× RF section 20 of the mobile communication terminal 100 is receiving pilot signals from the 1× system section 200 of the base station BS2 and the 1× system sections 200 of the four peripheral base stations BS1, BS3, BS4, and BS5, respectively. On the one hand, it is assumed that, in the EVDO system, the EVDO RF section 30 is receiving pilot signals from the EVDO system section 201 of the base station BS2 and the EVDO system sections 210 of the two peripheral base stations BS3 and BS5.

At this time, electromagnetic wave statuses of BS3 and BS5 suffer deterioration, and on the EVDO system side, when a situation, in which the EVDO RF section 30 can not receive a pilot signal from any one of the connected base station BS2 and the peripheral base stations BS3 and BS5 for more than predetermined number of times (e.g., more than 3 times), continues, the control section 40 judges that “the terminal 100 is in a status of an outside of a service area of the EVDO system”, and the reception-halt control section 42 of the control section 40 halts a receiving operation of a pilot signal (S1).

After that, in case that predetermined period (300 seconds), which is longer than the predetermined cycle, has passed (YES of S2), the reception-resume control section 43 of the control section 40 resumes of a receiving operation of a pilot signal at predetermined cyclic intervals (5.12 seconds) on the EVDO system side (S4).

On the one hand, if a predetermined period (300 seconds), which exceeds the predetermined cycle, has not yet passed (NO of S2), the control section 40 judges, on the 1× system side, whether handoff processing is performed or not (S3). In a CDMA2000 system, signals are spectrum-spread by use of a PN (Pseudo Noise) code which is different with respect to each base station, and therefore, it is all right if a PN code of a connected base station and a 1 cycle earlier PN code of the connected base station are compared, every time a pilot signal is received. If they are the same PN codes, the connected base station has not been changed, and therefore, it can be judged that handoff has not been performed, and if they are different PN codes, the connected base station was changed, and therefore, it can be judged that handoff has been performed.

Here, assuming that the mobile communication terminal 100 has moved from the cell C2 to the cell C4 because of movement of a user, in the 1× EVDO system, signal quality of a pilot signal from BS4, among the five base stations BS1-BS5, becomes the strongest, and therefore, the handoff processing section 41 of the control section 40 performs handoff processing, and switches the connected base station to BS4. At this time, the control section 40 can judge that handoff is performed since a PN code of the former connected base station BS2 and a PN code of the new connected base station BS4 are different (YES of S3).

Then, since the 1× system has performed handoff processing, the reception-resume control section 43 of the control section 40 drives the EVDO RF section 30 to resume reception of a pilot signal at predetermined period intervals of 5.12 seconds, although predetermined period (300 seconds), which exceeds a predetermined cycle, has not yet passed (S4).

Then, if an electromagnetic wave status of the EVDO system section 210 of the base station BS4 is favorable, the EVDO RF section 30 can receive a pilot signal from the EVDO system section 210, and the terminal 100 can go back to a status of an inside of a service area promptly, by using the base station BS4 as a connected base station. In addition, even if an electromagnetic wave status of the EVDO system section 210 of the base station BS4 is not sufficiently favorable, in case that the base station BS4 becomes a connected base station and peripheral base stations are recognized newly, it is possible to receive pilot signals also from these peripheral base stations.

Meanwhile, in S3, in case that it is judged that handoff processing is not performed on the 1× system side (NO of S3), the process returns to S2.

As above, even if it is not possible to receive pilot signals from a connected base station and peripheral base stations on the EVDO system side and it is judged that the terminal 100 is an outside of a service area, if handoff processing is performed by a user's movement, etc., on the 1× system side, statuses of a connected base station and peripheral base stations change on the EVDO system side, and therefore, it is possible to heighten such a possibility that pilot signal reception is resumed and the EVDO system can go back to a status of an inside of a service area promptly.

On that account, even if an electromagnetic wave status in a certain area is deteriorated suddenly due to a problem such as fading, it becomes possible to perform communication by the EVDO system in a short time, by user's movement to a peripheral area in which an electromagnetic wave status is good.

Meanwhile, in the embodiment of the present invention, as the mobile communication terminal 100, a portable telephone implemented in relation to CDMA2000 1× NC and CDMA2000 1× EVDO is explained as an example, but there is no need to limit to this case. It is needless to say that it is applicable to, for example, one implemented in relation to W-CDMA (Wideband-CDMA), and systems between GSM (Global system for Mobile communication) and GPRS (General Packet Radio Service), etc.

In addition, in the embodiment of the present invention, the example, in which a predetermined cycle of receiving a pilot signal is set to 5.12 seconds in the 1× system and the EVDO system, is shown, but there is no need to limit to this case. It is possible for a service provider (communication carrier, mobile communication terminal manufacturer, etc.) to arbitrarily set the cycle.

Moreover, in the embodiment of the present invention, the example, in which the base station is equipped with the 1× system section and the EVDO system section is shown, but there is no need to limit to this case. There may be a base station equipped with the 1× system section, and another base station equipped with the EVDO system section in the communication system, which means, the 1× system section and the EVDO system section may be provided in the different base station.

Furthermore, in the embodiment of the present invention, the example, in which a predetermined period of halting reception of a pilot signal is set to 300 seconds in the EVDO system, is shown, but there is no need to limit to this case. It is possible for a service provider (communication carrier, mobile communication terminal manufacturer, etc.) to arbitrarily set the period.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A mobile communication terminal for performing communication by a first communication system and a second communication system respectively, the mobile communication terminal comprising:
a first communication section which receives a signal transmitted from a connected base station of the first communication system, and a signal transmitted from a peripheral base station located at the periphery of the connected base station, respectively in a first cycle;
a second communication section which receives a signal transmitted from a connected base station of the second communication system, and a signal transmitted from a peripheral base station located at the periphery of the connected base station, respectively in a second cycle;
a reception-halt control section which performs a control so that the first communication section halts reception of the signal during a predetermined period which is longer than the first cycle, in a case where the first communication section fails in the reception of the signal more than a predetermined number of times;
a handoff processing section which performs handoff processing for switching between the connected base station and the base station to be connected based on a signal quality of the signal received by the second communication section; and
a reception-resume control section which performs a control so as to resume the reception of the signal by the first communication section, when the handoff processing section performs the handoff processing of the second communication system while the reception of the signal by the first communication system is halted.

2. The mobile communication terminal as claimed in claim 1, wherein the first communication system is CDMA2000 1× EVDO system, and the second communication system is CDMA2000 1× MC system.

3. A communication control method in a mobile communication terminal for performing communication by a first communication system and a second communication system respectively, the communication control method comprising:
receiving a first signal transmitted from a connected base station of the first communication system, and a first signal transmitted from a peripheral base station located at the periphery of the connected base station, respectively in a first cycle;
receiving a second signal transmitted from a connected base station of the second communication system, and a second signal transmitted from a peripheral base station located at the periphery of the connected base station, respectively in a second cycle;
performing handoff processing for switching between the connected base station and the base station to be connected based on a signal quality of the received second signal;
performing a control so that the reception of the first signal by the first communication system is halted during a predetermined period which is longer than the first cycle, in a case where the reception of the first signal is failed more than a predetermined number of times; and
performing a control so as to resume the reception of the first signal by the first communication system, when the handoff processing of the second communication system is performed while the reception of the first signal by the first communication system is halted.

4. The communication control method as claimed in claim 3, wherein the first communication system is CDMA2000 1× EVDO system, and the second communication system is CDMA2000 1× MC system.

5. A mobile communication terminal for performing communication by a first communication system and a second communication system respectively, the mobile communication terminal comprising:
a first communication section which receives a signal transmitted from a connected base station of the first communication system, and a signal transmitted from a peripheral base station located at the periphery of the connected base station, respectively in a first cycle;
a second communication section which receives a signal transmitted from a connected base station of the second communication system, and a signal transmitted from a peripheral base station located at the periphery of the connected base station, respectively in a second cycle; and
a control section which performs a control so that the first communication section halts reception of the signal during a predetermined period which is longer than the first cycle in a case where the first communication section fails in the reception of the signal transmitted from the connected base station of the first communication system and the signal transmitted from the peripheral base station respectively more than a predetermined number of times,
and so that the first communication section resumes the reception of the signal when a handoff processing for switching between the connected base station of the second communication system and the peripheral base station is detected while the reception of the signal by the first communication system is halted.

6. The mobile communication terminal as claimed in claim 5, wherein the control section detects whether the handoff processing is performed based on information transmitted from the connected base station of the second communication system.

7. The mobile communication terminal as claimed in claim 5, wherein the first communication system is CDMA2000 1× EVDO system, and the second communication system is CDMA2000 1× MC system.

8. The mobile communication terminal as claimed in claim 7, wherein the control section periodically detects a PN code that is transmitted from the connected base station of the second communication system, and detects whether the handoff processing is performed by comparing the received PN code with the PN code being received subsequently.
